(19) United States
(12) Patent Application Publication
(10) Pub. No.: US 2006/0088028 A1
(43) Pub. Date: Apr. 27, 2006

(54) Method for providing services of various service providers, and central, computer-based platform for implementing such a method

(76) Inventors: Thomas Leiber, Sebriesheim (DE); Andreas Boehm, Seeheim-Jugenheim (DE); Ralf Karge, Ludwigshafen (DE)

Correspondence Address: KENYON & KENYON LLP, ONE BROADWAY, NEW YORK, NY, 10004, US

(21) Appl. No.: 11/200,379

(22) Filed: Aug. 8, 2005

(30) Foreign Application Priority Data
Aug. 6, 2004 (DE) 102004038588.2

(51) Int. Cl. H04L 12/66

(52) U.S. Cl. 370/352

(57) ABSTRACT

A method and central computer-based platform for providing services of various service providers to one or more subscribers who can be assigned to different communications systems are provided. The method and system involve the provision of location-based services of various service providers to subscribers of various communications systems which can be easily and flexibly controlled. A plurality of subscribers, who can belong to different communications systems, are logged onto a central device to which various service provider(s) are assigned. Authorization data of at least one subscriber, which authorizes the service provider(s) to make one or more services available to the at least one subscriber, are subsequently stored in the central device. Localization data of the logged-on subscribers are transmitted to the central device and stored there. The authorized service providers make services available to the subscribers as a function of the subscriber-based localization data.

### FIELD OF INVENTION

The present invention relates to a method for providing services of various service providers to one or more subscribers who can be assigned to different communications systems, as well as a central, computer-based platform designed for implementing the method.

### BACKGROUND INFORMATION

So-called location-based services (LBS) are believed to have a wide field of application in the future in the mobile communications sector. Location-based services utilize the possibility of being able to locate a switched-on user terminal at any time, and based on the ascertained whereabouts of the specific user terminal, to offer customized services and/or information from this vicinity.

Mobile radio communications subscribers who want services and information depending on their whereabouts must log on to the specific service providers; each service provider must manage the logged-on subscribers itself. This means that the localization data of each subscriber logged on to a service provider must be transmitted to it, and each service provider itself must determine if and when it is allowed to make what services available to a subscriber. The expenditure for hardware and software on the part of the service providers increases further if subscribers of various communications systems are to be served, since as a rule, the communications systems have manufacturer-specific interfaces, all of which must be implemented in the server of a service provider. The various communications systems may be GSM (global system for mobile communications), GPS (global positioning system), Assisted GPS, UMTS (universal mobile telecommunications system), WLAN (wireless local area network), DVB-x (digital video broadcast) or RFID (radio frequency identification) supported communications systems.

### SUMMARY OF THE INVENTION

Embodiments of the present invention provide a method and a platform by which the provision of location-based services of various service providers to subscribers of various communications systems may be easily and flexibly controlled.

Additional and/or alternative embodiments provide for the creation of a platform as a central interface for the collection and management of localization date of logged-on subscribers, as well as the transmission of the localization data to service providers logged on to the platform. The localization data may then be made available for use to selected, logged-on service providers, taking into account personal preferences and desires of the respective subscribers.

Additional and/or alternative embodiments provide a method for providing services of various service providers to at least one subscriber. The subscribers may be assigned to various communications systems, services being provided depending on the whereabouts of the subscriber(s). The communications systems may be wire-bound and/or non-wire-bound communications systems. Wireless communications systems can be, for example, mobile telephony networks, GPS satellite transmission systems, broadcasting systems for the transmission of digital audio data or video data and the like.

In additional and/or alternative embodiments, to be able to centrally control the provision of services of various service providers to at least one subscriber, a plurality of subscribers are logged on to a central device. In addition, various service providers which would like to offer their services to the subscribers are assigned to the central device. Moreover, authorization data of at least one subscriber is stored in the central device. The authorization data involves information which authorizes one or more service providers to make one or more services available to the at least one subscriber. Furthermore, localization data of the logged-on subscribers is transmitted to the central device and stored there, the authorized service providers making services available to the respective subscribers as a function of the subscriber-based localization data.

Further additional and/or alternative embodiments involve collecting accounting-relevant data in the central device for each logged-on subscriber.

Further additional or alternative embodiments involve communications systems which include wireless and/or wire-bound communications networks based on different transmission technologies.

The subscriber-based localization data are expediently transmitted from the respective subscriber, who, for example, has his/her own GPS transmitter/receiver, and/or from the respective communications system(s), to the central device. Used for this purpose are, for example, the base stations of a mobile telephony network, which record the localization data of their subscribers.

The servers of the various service providers are connected or expediently connected via standardized interfaces, e.g., Web interfaces, to the central device. And, the communications systems are connected via proprietary interfaces to the central device.

If a service provider would like to offer its services to a logged-on subscriber, it can first of all request the corresponding subscriber-based localization data from the central device. To that end, an identification parameter of the logged-on subscriber is used, which is stored in the central device and at the service provider. This identification parameter may be a user name, a pseudonym, a telephone number of a fixed network, a mobile directory number (mobile station international subscriber directory number, MSISDN), a medium access control address (MAC, medium access control) or another suitable identification parameter. The central device only transmits the requested subscriber-based localization data to the service provider if the previously stored authorization data of the logged-on subscriber signal that the service provider has been authorized by the subscriber to offer services to this subscriber.

Alternatively or additionally, as a function of the subscriber-specific authorization data, the subscriber-based localization data and predetermined rule(s), the central device informs one or more of the authorized service providers about the location or state of at least one subscriber. These rules are so-called notification rules which relate, for instance, to a change in position of a subscriber, or the information that a subscriber has moved out of or into a defined geographical region.

In additional and/or alternative embodiments, the subscriber-specific authorization data may contain time-based information. This means that a subscriber is able to stipulate times or time spans during which a specific service provider is authorized to offer location-based services to this subscriber.

In additional and/or alternative embodiments, when the subscribers log on to the central device, subscriber-specific identification parameters are expediently stored, which are used by a service provider, for instance, to request subscriber-based localization data at the central device.

In additional and/or alternative embodiments, the localization data of the logged-on subscribers are updated at regular intervals or at predeterminable points of time.

In additional and/or alternative embodiments, if the localization data define the whereabouts of mobile subscribers, individual movement profiles may be calculated for each logged-on, mobile subscriber. For example, the movement profiles may define the following states of movement:

The user is moving quickly.

The user is moving slowly.

The user is not moving at the moment.

The user has no longer moved for n hours.

In additional and/or alternative embodiments, the future whereabouts of the respective mobile subscribers may be calculated from the individual movement profiles. In addition to the calculation of the future location, the moment at which a subscriber will reach this location may also be ascertained. In this, it is possible to inform a service provider of the moment at which a subscriber will enter its service area. The service provider then no longer has to rely on regularly requesting localization data of the logged-on subscribers from the central device, or has to be informed by the central device about relevant position changes. Rather, it can be sufficient that the service provider monitor the instantaneous time and automatically make a location-based service available to a subscriber as soon as the previously calculated moment of entry of the subscriber into the service area of the service provider has been reached.

In additional and/or alternative embodiments, a suitable method which, based on collected and stored information from the past, carries out statistical calculations to recognize early on what route a mobile subscriber will select. See, e.g., German patent reference 103 21 561 A1.

In additional and/or alternative embodiments, the central, computer-based platform has first interfaces for communicating with servers of various service providers, second interfaces for communicating with communications systems and/or with subscribers assigned to the communications systems. Also provided are a first storage device for storing identification parameters of logged-on subscribers, a second storage device for storing authorization data of at least one logged-on subscriber which authorize the service provider(s) to make one or more services available to the at least one subscriber, as well as a third storage device for storing localization data of logged-on subscribers. Provided as well is a device for controlling the transmission of localization data to at least one server as a function of the stored identification parameters and authorization data.

In additional and/or alternative embodiments, an externally controllable device is provided for defining geographic zones, for assigning the geographic zones to one or more servers, and for defining rules with regard to the geographic zones. As a function of the received and managed localization data of logged-on subscribers, the central, computer-based platform is able to determine when a subscriber enters a specific geographic zone corresponding to the service area of a specific service provider, and to dispatch a corresponding notification to the service provider.

In additional and/or alternative embodiments, a device is provided for generating a notification for one or more servers as a function of the authorization data and/or the subscriber-based localization data and the rules.

In additional and/or alternative embodiments, the first interfaces are standardized interfaces, e.g., Web interfaces, and the second interfaces are manufacturer-specific interfaces.

In additional and/or alternative embodiments, a device is expediently provided for updating the localization data of logged-on subscribers.

In additional and/or alternative embodiments, it is necessary to update the localization data if movement profiles are to be ascertained for mobile subscribers. A computing device, which calculates individual states of movement and/or individual movement profiles from stored localization data of mobile subscribers, is used for this purpose; the movement profiles may be stored in a fourth storage device.

In additional and/or alternative embodiments, the future whereabouts of the respective mobile subscribers may be calculated from the individual movement profiles by a prediction device.

In additional and/or alternative embodiments, to record communications data records, an accounting device is provided which is able to relay the collected accounting data via the Internet, for example, to an accounting center.

The services and/or information of the service providers are made available to the subscribers via the communications system at which the respective subscribers are logged on. In this context, the central, computer-based platform may—but does not have to—be used as control node and/or switching node between the servers of the service providers and the communications systems.

### BRIEF DESCRIPTION OF THE DRAWING

FIG. 1 shows an embodiment of the central, computer-based platform of the present invention.

### DETAILED DESCRIPTION

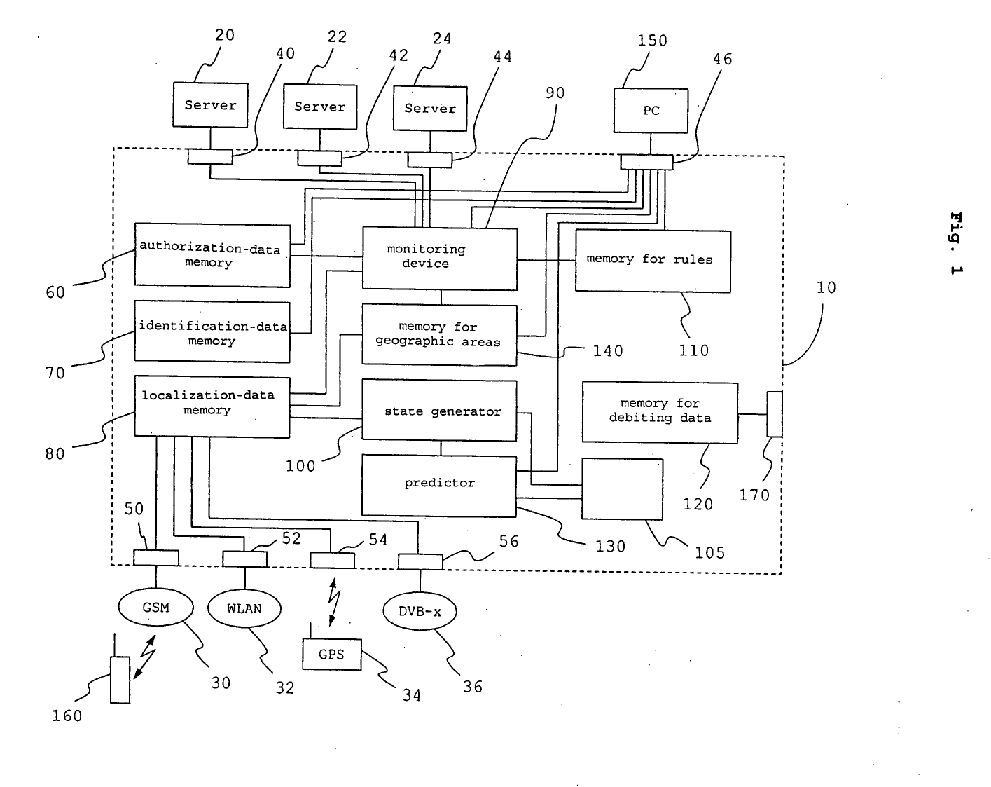

FIG. 1 shows a central, computer-based platform, designated by reference numeral 10, which may also be called a permission and privacy gateway (PPGW). Platform 10 may be made up of a single computer or a computer and memory network. Servers 20, 22 and 24 of various service providers are connected to central, computer-based platform 10 via interfaces 40, 42 and 44, respectively. Interfaces 40, 42 and 44 are standardized interfaces, so that at any time, servers of other service providers may be added on or exchanged for servers of other service providers. Various communications systems 30, 32, 34 and 36, respectively, are connected to central, computer-based platform 10 via interfaces 50, 52, 54 and 56. For example, a GSM- and/or UMTS-mobile telephony network 30 is connected to interface 50 via a base station. A wireless, local network 32 is able to communicate with central, computer-based platform 10 via interface 52. A mobile terminal device 34 which has its own GPS transmitter/receiver is able to exchange data with platform 10 via interface 54. A wire-bound or wireless, digital video broadcasting network or a so-called RFID (radio frequency identification) network may be connected to interface 56. The authorization data, also known as declarations of consent, of logged-on subscribers, that define to which service provider a subscriber has granted the right to localize him/her, are stored in an authorization-data memory 60. The permission to localize subscribers may also be restricted by individual time profiles for different services and/or different service providers. The corresponding time profiles may be stored, for example, in a rules memory 110.

Moreover, an identification-data memory 70 is provided, in which identification parameters of the logged-on subscribers are stored. Identification parameters may be: user name, pseudonyms, telephone numbers of the fixed network, directory numbers of a mobile telephony network, a medium access control address of network boards and the like. The localization data of all logged-on subscribers are stored in a localization-data memory 80. The localization data of one or more subscribers updated during a session are logged in order to be able to calculate corresponding movement profiles for the respective logged-on subscribers.

The subscriber-specific localization data are transmitted from the communications networks, like, for example, networks 30, 32 and 36, at which the respective subscribers are logged on, via corresponding interfaces 50, 52 and 56, respectively, to localization-data memory 80. Terminal devices equipped with a GPS transmitter/receiver, such as user terminal 34, generate their localization data themselves and transmit it, for instance, via radio interface 54 to localization-data memory 80.

A state generator 100 is also connected to localization-data memory 80. From the stored subscriber-based localization data, state generator 100 generates states of movement and/or movement profiles for each logged-on, mobile subscriber. For example, the states of movement may be:

The user is moving quickly.

The user is moving slowly.

The user is not moving at the moment.

The user has no longer moved for n hours.

The movement profiles calculated by state generator 100 are provided to a predictor 130. Based on the movement profiles provided to it by state generator 100, predictor 130 ascertains a prediction about a future location of the respective subscribers.

For example, geographic zones that correspond to the service area of one or more service providers may be defined via a personal computer 150 connected to central, computer-based platform 10. The geographic zone data are stored in a memory 140. Memory 140 is connected to localization-data memory 80, memory 110 and a monitoring device 90. In rules memory 110, rules may be stored, for instance, which stipulate when monitoring device 90 transmits a specific notification message to one or more servers of different service providers. The rules may stipulate that a server of a specific service provider receives a message via monitoring device 90 when a logged-on subscriber enters or leaves a previously defined zone. The notification then informs the respective server that the specific subscriber has now arrived in the service area of the respective service provider and thus has consented to the service provider making location-based services and/or information available to him/her.

Furthermore, a billing or accounting device 120 is provided that generates and collects communications data records or accounting-related data for the respective logged-on subscribers and transmits it, for example, via an interface 170 by way of the Internet to a central accounting center (not shown).

Subscribers are able to register at central, computer-based platform 10 via externally connectable personal computer 150, by storing their specific identification parameters in memory 70 and their corresponding authorization data in memory 60.

Authorization data, as well as identification parameters of logged-on subscribers may be erased or altered, for example, with the aid of personal computer 150. Likewise, the geographic zones stored in memory 140 may be defined, altered or erased via external personal computer 150. The same holds true for the rules stored in rules memory 110. At this point, it should be pointed out that instead of personal computer 150, any user terminal, e.g., user terminal 34, may also be used to program platform 10.

The data of the logged-on users as well as the movement profiles may be queried with the aid of externally connectable personal computer 150 or the user terminals, e.g., a cellular phone 160, logged on to the respective communications networks. Taking into account statistical methods, it is likewise possible with the aid of predictor 130 to calculate the future location, as well as the time of entry into a future location, of a specific subscriber, and to again query this data, for instance, via external personal computer 150. To that end, predictor 130 is able to communicate with PC 150 via interface 46.

Communications networks 30, 32 and 36 as well as user terminal 34 connected to interfaces 50, 52, 54 and 56 may also be generally labeled as so-called localization provider. To be understood by localization provider is, quite generally, devices which generate localization information of the subscribers logged on to central, computer-based platform 10 and transmit it to location-data memory 80.

The functioning method of central, computer-based platform 10 illustrated in the figure is explained in one way in the following example.

For example, a user of cellular phone 160, which is logged on to GSM mobile telephony network 30, would like to register at central, computer-based platform 10 with respect to servers 20 and 22.

The log-on request may take place via mobile user terminal 160 or via personal computer 150. The log-on request of subscriber 160 may take place via personal computer 150, which consequently may be connected not only to central, computer-based platform 10, but also to servers 20 and 22, e.g., via the Internet.

Identification parameters of new subscriber 160 are input at personal computer 150 and transmitted to memory 70 of central, computer-based platform 10, provided subscriber 160 is not yet registered at central, computer-based platform 10. Central, computer-based platform 10 is subsequently signaled via personal computer 150 that subscriber 160 would like to log on to servers 20 and 22. Central, computer-based platform 10 thereupon generates two transaction numbers TAN₁ and TAN₂ and transmits them to personal computer 150. Personal computer 150 or platform 10 transmits transaction number TAN₁ together with the identification parameters of subscriber 160 to server 20, and the identification parameters of subscriber 160 together with transaction number TAN₂ to server 22. In this way, subscriber 160 is logged on to servers 20 and 22. The two transaction numbers TAN₁ and TAN₂ are optionally transmitted by the two servers 20 and 22 back to central, computer-based platform 10 and stored in identification-parameters memory 70. In this way, servers 20 and 22 confirm to the platform that the subscriber has been logged on to servers 20 and 22.

Moreover, at this point authorization data with respect to subscriber 160 are input at personal computer 150 and written into memory 60 of central, computer-based platform 10. The authorization data correspond to a declaration of consent by subscriber 160 that servers 20 and 22 are allowed to transmit location-specific services and/or information to subscriber 160.

In a further example, assume that geographic zones which correspond to the regional service area of servers 20 and 22 are defined at personal computer 150. The data defining the geographic zones are then written by personal computer 150 into memory 140 of the central, computer-based platform. Also defined at personal computer 150 are rules which stipulate, for example, that when subscriber 160 enters the regional service area of server 20 or the regional service area of server 22, a corresponding notification is sent to server 20 or 22. For example, additionally a time-dependent rule may be stored in memory 110 which defines that server 20 is only allowed to transmit location-specific services to subscriber 160 between 17 and 24 hours, while server 22 is only allowed to transmit location-dependent data to subscriber 160 on Sundays.

Although the following functional description is explained only by the example of subscriber 160, central, computer-based platform 10 is able to manage a plurality of logged-on subscribers and servers simultaneously. In addition, a plurality of subscribers is able to be newly registered or deleted at the same time.

In a further example, assume that the localization data of subscriber 160, which correspond to his/her instantaneous location, is acquired by GSM mobile telephony network 30 and transmitted at regular intervals or at predetermined moments to location-data memory 80 of central, computer-based platform 10.

Monitoring device 90 may be designed in such a way that at regular intervals, it compares the localization data, stored in location-data memory 80 for subscriber 160, to the geographic zones stored in memory 140. As soon as monitoring device 90 determines that subscriber 160 is in the geographic zone assigned to server 20 or server 22, it checks the subscriber-specific rules stored in rules memory 110.

In a further example, assume that subscriber 160 has just now entered the geographic zone, i.e., the service area assigned to server 20. Monitoring device 90 thereupon checks the contents of rules memory 110. The rules relevant for the geographic area of server 20 say that server 20, i.e., the associated service provider, is only allowed to transmit location-specific services or information to subscriber 160 between 17 and 24 hours. If the rule applies and a corresponding declaration of consent with respect to subscriber 160 for server 20 is in memory 60, monitoring device 90 transmits a corresponding notification to server 20, which thereupon transmits location-specific services or suitable information via GSM mobile telephony network 30 to subscriber 160. The provision of services and communications of information from server 20 to subscriber 160 may be carried out with or without switching of platform 10. (Direct connections between servers 20, 22 and 24 and communications systems 30, 32, 34 and 36 are not shown in the figure).

According to a further development of central, computer-based platform 10, state generator 100 is able to generate subscriber-specific movement profiles from the localization data recorded with respect to subscriber 160. To that end, not only instantaneous localization data, but also localization data collected and logged over several days, weeks or months may be utilized to generate movement profiles for a logged-on subscriber. Predictor 130 can be designed in such a way that, as a function of the calculated movement profiles of subscriber 160, it is able to calculate the possible route of subscriber 160, and thus the future locations and possibly even the moment a future location will be reached. In conjunction with monitoring device 90, which knows the declarations of consent of subscriber 160, the geographic zone, as well as the rules in force for subscriber 160, corresponding notifications may thus be transmitted to server 20 or 22 before subscriber 160 has entered the relevant, previously defined geographic zone.

If corresponding rules exist, monitoring device 90 also notifies servers 20 and 22 that subscriber 160 has left a geographic zone again, so that location-based services no longer have to be made available to subscriber 160.

While location-specific services or information are being made available, debiting device 120 of central, computer-based platform 10 ascertains corresponding communications or debiting data records which, for example, may be transmitted via the Internet to a central debiting center.

In addition to the possibility of monitoring device 90 informing servers 20, 22 and 24 about if and when the subscriber is entering a geographic zone that corresponds to the regional service area of server 20 or 22, the servers themselves may request the localization data of certain subscribers at central, computer-based platform 10. To that end, for example, server 20 transmits an identification parameter of subscriber 160, which it has received during the log-on of subscriber 160, to central, computer-based platform 150. For instance, monitoring device 90 is designed to compare the transmitted identification parameter to the identification parameters stored in memory 70. If the comparison shows that subscriber 160 asked about is logged on to the central, computer-based platform, it is checked whether relevant authorization data are stored in memory 60 with respect to server 20. If subscriber 160 has granted server 20 a corresponding authorization to offer location-based services, central, computer-based platform 150 transmits the instantaneous localization data to server 20. Server 20 then checks independently whether subscriber 160 is within its regional service area. If yes, it makes suitable, location-based services available, otherwise not.

In further examples, even if server 20 requests the transmission of subscriber-specific localization data, monitoring device 90 only transmits localization data of subscriber 160 to authorized server 20 when subscriber 160 is in the previously defined geographic zone whose data are stored in memory 140, and the rules stored in memory 110 are satisfied.

What is claimed is:

1. A method for providing services of various service providers to at least one subscriber as a function of the location of the at least one subscriber, comprising:
logging a plurality of subscribers onto a central device;
assigning at least one service provider to the central device;
storing authorization data of at least one subscriber of the plurality of subscribers in the central device, the authorization data authorizing the at least one service provider to make at least one service available to the at least one subscriber;
transmitting localization data of each respective subscriber of the plurality of subscribers which are logged on the central device to the central device;
storing the localization data in the central device,
wherein respective authorized service providers of the at least one service provider makes at least one service available to the respective subscriber as a function of the respective subscriber-based localization data.

2. The method of claim 1, wherein each respective subscriber of the plurality of subscribers belonging to a respective communication system, wherein each respective communication system associated with each respective subscriber is different from each other.

3. The method as recited in claim 1, further comprising transmitting the respective subscriber-based localization data from at least one of the respective subscriber and the respective communication system to the central device.

4. The method as recited in claim 1, further comprising:
requesting the respective subscriber-based localization data by the at least one service provider from the central device; and
transmitting the respective subscriber-based localization data to only respective authorized service providers.

5. The method as recited in claim 1, further comprising:
informing at least one respective authorized service provider by the central device about a state of the respective subscriber, as a function of the authorization data, the respective subscriber-based localization data and any predetermined rule.

6. The method as recited in claim 1, wherein the respective subscriber authorization data includes time-based information.

7. The method as recited in claim 1, wherein upon log-on of the respective subscriber at the central device, respective subscriber-specific identification parameter is stored.

8. The method as recited in claim 1, wherein the plurality of subscribers include at least one mobile subscriber, and further comprising updating the respective localization data of the logged-on respective subscriber.

9. The method as recited in claim 8, further comprising calculating respective individual movement profiles from the stored respective localization data of the at least one mobile subscriber.

10. The method as recited in claim 9, further comprising calculating the respective future location of each respective mobile subscriber from the respective individual movement profile.

11. The method as recited in claim 1, further comprising collecting accounting-relevant data in the central device for each logged-on respective subscriber.

12. The method as recited in claim 1, wherein the communication systems include wireless and/or wire-bound communication networks based on different transmission technologies.

13. A central, computer-based platform comprising:
at least one first interface for communicating with at least one server belonging to at least one service provider;
at least one second interface for communicating with at least one of a communication system and a subscriber assigned to the respective communication system;
a first storage device for storing identification parameter of a logged-on subscriber;
a second storage device for storing authorization data of the logged-on subscriber, which authorizes the at least one service provider to make at least one service available to the logged-on subscriber;
a third storage device for storing localization data of the logged-on subscriber;
a device for controlling the transmission of localization data to at least one server as a function of the stored identification parameter and authorization data.

14. The central, computer-based platform as recited in claim 13, further comprising an externally controllable device, wherein the externally controllable device is configured to define geographic zones, assign the geographic zones to at least one server, and define at least one rule with regard to the geographic zones.

15. The central, computer-based platform as recited in claim 14, further comprising a device for generating a notification for at least one server as a function of the subscriber-based localization data and the at least one rule.

16. The central, computer-based platform as recited in claim 13, wherein the at least one first interface is a standardized interface, and the at least one second interface is a manufacturer-specific interface.

17. The central, computer-based platform as recited in claim 16, wherein the standardized interface is a World Wide Web interface.

18. The central, computer-based platform as recited in claim 13, further comprising a device for updating the localization data of logged-on subscriber.

19. The central, computer-based platform as recited in claim 18, further comprising:
a computing device for calculating at least one of individual states of movement and individual movement profiles from the stored localization data of any mobile subscribers; and
a fourth storage device for storing individual movement profiles.

20. The central, computer-based platform as recited in claim 19, further comprising a prediction device for calculating future locations of the respective mobile subscribers from the individual movement profiles.

21. The central, computer-based platform as recited in claim 13, further comprising an accounting device.
